(19) United States
(12) Patent Application Publication
(10) Pub. No.: US 2009/0192991 A1
(43) Pub. Date: Jul. 30, 2009

(54) NETWORK INFORMATION SEARCHING METHOD BY SPEECH RECOGNITION AND SYSTEM FOR THE SAME

(75) Inventors: Chao-Jen Huang, Taipei (TW); Liang-Sheng Huang, Taipei City (TW); Jia-Lin Shen, Taipei (TW)

Correspondence Address: J C PATENTS, INC., 4 VENTURE, SUITE 250, IRVINE, CA, 92618, US

(73) Assignee: DELTA ELECTRONICS, INC., Taoyuan Hsien (TW)

(21) Appl. No.: 12/108,806

(22) Filed: Apr. 24, 2008

(30) Foreign Application Priority Data
Jan. 24, 2008 (TW) 97102645

(51) Int. Cl. G06F 17/30; G10L 15/00

(52) U.S. Cl. 707/3; 704/251; 707/E17.108; 704/E15.001

(57) ABSTRACT

A network information searching method for a search engine system is provided. The search engine system is capable of searching with a plurality of web-site search engines. First, a voice signal is processed for speech recognition to generate a literal word series, in which the voice signal conforms to a grammatical format and includes a designated group and a keyword. Then, the literal word series is analyzed according to the grammatical format, so as to retrieve the designated group and the keyword from the literal word series. The retrieved designated group and keyword are transmitted to the search engine system. The search engine system selects a suitable web-site search engine according to the designated group to search for the keyword online, and obtain a searched result thereby.

### CROSS-REFERENCE TO RELATED APPLICATION

This application claims the priority benefit of Taiwan application serial no. 97102645, filed on Jan. 24, 2008. The entirety of the above-mentioned patent application is hereby incorporated by reference herein and made a part of specification.

### BACKGROUND OF THE INVENTION

1. Field of the Invention

The present invention generally relates to a network information searching method and a system for the same, and more particularly, to a network information searching method by speech recognition.

2. Description of Related Art

As the electronic technology being developed, and wireless communication and internet becoming more popular, slim, small portable apparatuses are gradually becoming typical platforms for accessing data in new generation. Facilitated by laptop computers, personal digital assistants (PDAs), or cell phones, modern people are allowed to conduct information searching, exchanging, and sharing by linking to internet at anytime from anywhere.

In the past, when a user intended to search information from a network, he must start a specific portal website, such as, Yahoo.com, Google.com, or Yam.com, and input keywords in the search field with an input/output apparatus such as a keyboard, a mouse, or a touch control screen, to conduct the network information searching. However, such input/output apparatus, i.e., screen, keyboard, or mouse, is not equipped to every electronic product. On the other hand, the portable apparatuses are very much restricted by the sizes, and are thus equipped with simplified input/output apparatuses. Such simplified input/output apparatuses are therefore inconvenient for the user to operate for searching information. For example, in a cell phone, often a single key is designed for inputting several letters, so that the user has to repetitively press the same key to select the desired letter. A cell phone using a touch control screen also requires pointing the desired letter on the screen for inputting.

As such, it is highly desirable to control human-machine interfaces between human beings and the smart apparatuses with the most convenient communication medium, speech, which can effectively improve the convenience of network information searching.

### SUMMARY OF THE INVENTION

Accordingly, the present invention is directed to a network information searching method and a system for the same. The present invention employs a speech recognition technology and a search engine system for searching information on the internet via voice input. In an embodiment of the present invention, a suitable web-site search engine is selected to searching for a keyword according to the speech recognition result. And therefore, the searching of desired information or even effectively compiling the desired information may be effectively implemented.

The present invention provides a network information searching method adapted for a search engine system. The search engine system is capable of searching with a plurality of web-site search engines. First, a voice signal including a designated group and a keyword is processed for speech recognition, so as to obtain a literal word series, in which the voice signal conforms to a grammatical format. Then, the literal word series is analyzed according to the grammatical format, so as to retrieve the designated group and the keyword from the literal word series. The retrieved designated group and keyword are then transmitted to the search engine system. The search engine system then selects a suitable web-site search engine according to the designated group to search for the keyword online, and obtain a searched result thereby.

The present invention provides a network information searching system. The network information searching system includes a speech recognition module, a parsing module, and a search engine system capable of searching with a plurality of web-site search engines. The speech recognition module receives a voice signal which conforms to a grammatical format and includes a designated group and a keyword. The speech recognition module processes the voice signal for speech recognition so as to obtain a literal word series. The analysis module analyses the literal word series according to the grammatical format, and retrieves the designated group and the keyword therefrom, so as to allow the search engine system to search according to the designated group and the keyword, and thus generating a searched result.

According to an embodiment of the present invention, the foregoing designated group is one of the web-site search engines.

According to an embodiment of the present invention, the foregoing designated group is a group set including the relative web-site search engines.

In general, the present invention conducts a network information search via voice input. In such a way, the present invention converts the voice signal which conforms to the grammatical format into a literal word series in a digital data form by speech recognition. Then the designated group and the keyword are retrieved from the literal word series and accorded as a searching condition of the search engine system. The search engine system selects a suitable web-site search engine according to the designated group to search for the keyword, and thereby improving a searching efficiency. While the information searched by different web-site search engines are not entirely the same, the present invention allows the user to obtain desired information corresponding to the different web-site search engines by inputting a voice instruction for once, and thus improving the usage convenience.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is block diagram illustrating a network information searching system according to an embodiment of the present invention.

FIG. 2 is a schematic diagram illustrating a search engine system according to an embodiment of the present invention.

FIG. 3 is a flow chart illustrating a network information searching method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

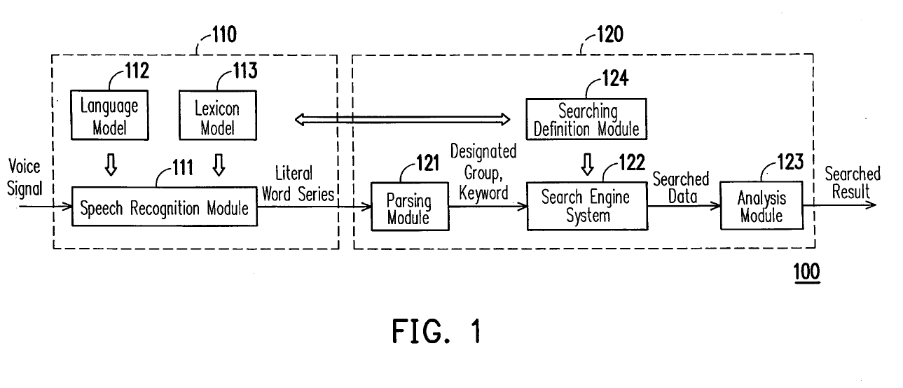

FIG. 1 is block diagram illustrating a network information searching system according to an embodiment of the present invention. Referring to FIG. 1, the network information searching system 100 includes a speech recognition module 111, a language model 112, a lexicon model 113, a parsing module 121, a search engine system 122, an analysis module 123, and a searching definition module 124. The search engine system 122 is capable of searching in accordance with a plurality of web-site search engines, in which the web-site search engines are classified as being identifiable, such as snack, real estate, stock. According to an aspect of the embodiment, the network information searching system 100 is exemplified by discussion about a speech recognition process 110, and a network information searching process 120.

In the speech recognition process 110, a user input a voice signal which conforms to a grammatical format, the voice signal including a designated group and a keyword which can later serve as a searching condition for the sequent network information searching process 120. Supposing that the grammatical format is “go to ‘SOMEWHERE’ to find out ‘SOMETHING’”, the user is correspondingly required to input a voice signal of “go to ‘DESIGNATED GROUP’ to find out ‘KEYWORD’”. Then, the analog voice signal is then transferred to the speech recognition module 111. The speech recognition module 111 performs a speech recognition process on the voice signal for obtaining a literal word series in a digital data form.

In the meantime, the speech recognition module 111 retrieves a voice frame from the voice signal, and determines a characteristic helpful for speech recognition from the voice frame, such as a Me-frequency cepstral coefficient (MFCC). Then, the speech recognition module 111 compares the characteristic with a probability function of phoneme, syllable, or word built in an acoustic model (not shown), so as to identify what is the voice of the voice frame contained in the voice signal. The lexicon model 113 includes a plurality of words. The speech recognition module 111 searches for words which may correspond to the voice from the lexicon model 113 in a way similar as looking up a dictionary. The language model 112 provides a grammatical assembly probability of the words to the speech recognition module 111 according to an interrelation between the searched words and the grammatical format. In such a way, the speech recognition module 111 selects those more relative words according to the grammatical assembly probability, and therefore correctly identifies words contained in the voice signal, and generates a literal word series. Principle of speech recognition is well understood by those skilled in the art, and therefore is not to be iterated hereby.

In network information searching process 120, the parsing module 121 analyzes the literal word series according to the grammatical format, and retrieves the designated group and the keyword from the literal word series, and therefore transmits the retrieved designated group and keyword to the search engine system 122. The search engine system 122 then selects a suitable web-site search engine to search for the keyword according to the designated group, and generates searched data corresponding to each web-site search engine.

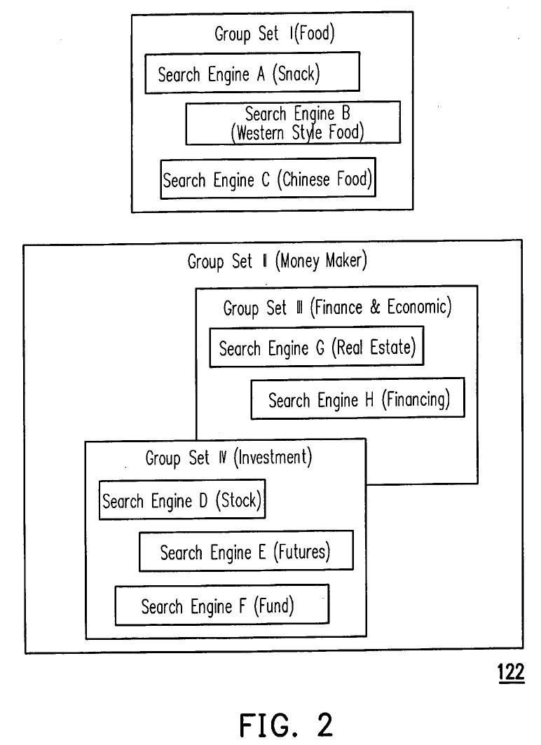

FIG. 2 is a schematic diagram illustrating a search engine system according to an embodiment of the present invention. Referring to FIG. 2, there is shown a search engine system 122 capable of searching in accordance with a plurality of web-site search engines and the web-site search engines (referred as search engine) are classified as being identifiable. For example, search engine A is classified as “Snack”, search engine B is classified as “Western Style Food”, and search engine C is classified as “Chinese Food”. When a user input a voice signal of “go to ‘search engine A” to find out ‘Taiwan Pan Cake’”, the voice signal is then converted into a literal word series in a digital data form by the speech recognition module 111. The parsing module 121 then analyzes the literal word series according to the grammatical format, and therefore retrieves “search engine A”, and “Taiwan Pan Cake”. Because the voice signal conforms to the grammatical format, the parsing module 121 automatically identifies that “search engine A” is the designated group, and “Taiwan Pan Cake” is the keyword.

In the meantime, the search engine system 122 selects the search engine A which corresponds to “Snack” to search for the keyword “Taiwan Pan Cake”. Considering the huge amount of information being supplied from the internet, in which even when only the search engine A is used to search for the keyword, there might be thousands or more searched data found thereby, the analysis module 123 is employed to eliminate the false and retain the true from the searched data. For example, the search engine A searches for the keyword “Taiwan Pan Cake” from the internet, and in sequence generates searched data A1, A2, A3, . . . Am. According to an aspect of the embodiment, the analysis module 123 selects the first N searched data as a searched result, and provides to the user. Assuming N=3, then the analysis module 123 selects A1, A2, and A3 as the searched result.

According to another embodiment of the present invention, the analysis module 123 conducts a similarity comparison of the searched data A1, A2, A3 . . . Am, and selects those having a predetermined weight as the searched result. For example, the analysis module 123 compares where there is any word (keyword) repetitively appeared in the searched data, the repetition degree, or compares whether there is any link interrelation among the searched data. When one of the searched data Aj is found satisfying the comparison condition, the analysis module 123 assigns a weight to the searching data Aj, in which 1≦j≦m. When the predetermined weight is set higher, the analysis module 123 selects searched data with a higher similarity as the searched result. On the contrary, when the predetermined weight is set lower, the analysis module 123 selects searched data with a lower similarity as the searched result.

Further, searching definition module 124 is adapted for defining the search engines, for example defining the search engine A as “Snack”. In such a way, the user may input a voice signal of “go to ‘Snack’ to find out ‘Taiwan Pan Cake’” to automatically designate the search engine A for searching information. The lexicon model 113 may also be expanded the words relative to the defined search engines by the searching definition module 124.

For the purpose of describing the present invention in more detail, another embodiment is described below. Referring to FIGS. 1 and 2, the user may define those search engines which are related one to another as a group set by the searching definition module 124. For example, search engines A (Snack), B (Western Style Food), and C (Chinese Food) are all related to food and are thus classified as the group set I; search engines D (Stock), E (Futures), and F (fund) are all related to investment and are thus classified as the group set II; and similarly search engines G (Real Estate), H (Financing) are classified as the group set III (finance and economic). The lexicon model 113 may also be expanded the words related to the defined group sets by the searching definition module 124.

When the user input a voice signal which conforms to the grammatical format, such as “go to ‘group set II’ to find ‘Delta Electronics’”, a literal word series will be generated in a digital data form by a speech recognition process. The parsing module 121 analyzes the literal word series according to the grammatical format, and retrieves “group set II” and “Delta Electronics” therefrom. Because the voice signal conforms to the grammatical format, the parsing module 1212 can automatically identify that the “group set II” is the designated group, and the “Delta Electronics” is the keyword. The “group set II” and the “Delta Electronics” are then transmitted to the search engine system 122. In the meantime, the search engine system 122 selects the search engines D (Stock), E (Futures), and F (fund) to search for the keyword “Delta Electronics”. For example, the searching obtains searched data D1, D2, D3 . . . corresponding to the search engine D, searched data E1, E2, E3 . . . , corresponding to the search engine E, and searched data F1, F2, F3 . . . , corresponding to the search engine F. According to an aspect of the embodiment, the analysis module 123 similarly compares the searched data, and selects those having a predetermined weight as the searched result, and provides it to the user.

For example, the predetermined weight (0-100) is set at 80, the analysis module 123 selects those searched data having higher similarities as the searched result to provide to the user. Otherwise, if the predetermined weight (0-100) is set at 20, the analysis module 123 selects those searched data having lower similarities as the searched result to provide to the user. According to another aspect of the embodiment, the analysis module 123 directly select the first N searched data as the searched result to provide to the user, in which the predetermined weight (0-100) can be set as 0.

It should be noted that although the voice signal which conforms to the grammatical format is exemplified with “go to ‘designated group’ to find ‘keyword’”, the present invention should not be construed as being restricted thereby. Accordingly, the inputted voice signal such as “go to ‘designated group 1’ and ‘designated group 2’ to find ‘keyword’”, or “go to ‘designated group’ to find ‘keyword 1’ and ‘keyword 2’”, or “go to ‘designated group’ to find out ‘keyword 1’ or ‘keyword 2’”, or the like to conduct the network information search shall also be construed to be within the scope of the present invention. Further, the designated group can be one of the search engines, or the group set including a plurality of search engines which are related one to another. For example, the inputted voice signal can be “go to ‘group set II’ and ‘search engine G’ to find ‘Delta Electronics’”, or “go to ‘group set II’ to find ‘Delta Electronics’ and “ChinaTrust”. Furthermore, the user may even define different group set which are related one to another as an upper level classification as shown in FIG. 2. For example, the group set IV is a money maker classification including the group set II (investment) and the group set III (finance and economic).

Furthermore, from the above description, one skilled in the art may adopt different grammatical formats to practice the teachings of the present invention. It should be noted that the present invention is not restricted by the aforementioned grammatical format as exemplified, and any inputted voice signal which conforms to a certain grammatical format, and the inputted voice signal contains a designated group and a keyword serving as the searching conditions for network information searching shall be construed to be within the scope of the present invention.

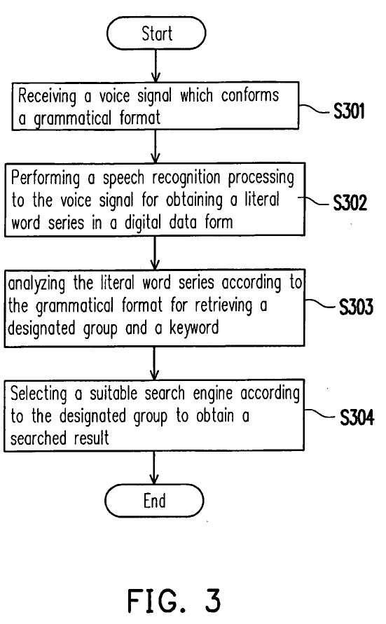

As illustrated in the foregoing embodiments, the procedure of the network information searching method can be concluded. FIG. 3 is a flow chart illustrating a network information searching method according to an embodiment of the present invention. Referring to FIG. 3, in step S301, a voice signal which conforms to a grammatical format is received, and the voice signal includes a designated group and a keyword. Next, in step S302, the voice signal is conducted with a speech recognition process, so as to convert the voice signal from an analog signal into a literal word series in a digital data form. Next, in step S303, the designated group and the keyword are retrieved from the literal word series by analyzing the literal word series according to the grammatical format, and the designated group and the keyword are transmitted to a search engine system which is capable of searching with a plurality of web-site search engines. The search engine system then select a suitable web-site search engine according to the designated group to search for the keyword in the step S304, in which the designated group can be either one of the web-site search engines, or a group set of the web-site search engines which are related one to another.

In summary, the present invention provides a network information searching method by speech recognition and a system for the same. By conducting speech recognition, the voice signal which conforms to the grammatical format is converted into the literal word series in the digital data form. Next, the designated group and the keyword are retrieved from the literal word series and accorded as a searching condition of the search engine system. The search engine system is adapted to select a suitable web-site search engine according to the designated group to search for the keyword, and thereby improving a searching efficiency. In other words, the present invention allows the user to select a suitable web-site search engine to searching for the keyword by inputting a voice instruction for once. As such, the user is not required to key in with a keyboard for searching and thus increasing the searching speed and increasing the convenience.

Moreover, when a keyword is used in network information, thousands of data may be obtained from different web-site search engines, while different web-site search engines may obtain different searched data. As such, an embodiment of the present invention proposes to select the first N searching data as the searched result, or compare the similarity of the searched data and select those having a predetermined weight as the searched result. In such a way, the user can search data from different web-site search engines, so as to drastically improve the efficiency of network information searching.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A network information searching method for a search engine system capable of searching with a plurality of web-site search engines, comprising:
receiving a voice signal, which conforms to a grammatical format and includes a designated group and a keyword;
performing a speech recognition process to the voice signal for obtaining a literal word series in a digital data form;
analyzing the literal word series according to the grammatical format for retrieving the designated group and the keyword therefrom; and
transmitting the designated group and the keyword to the search engine system, and searching with the searching engine system to obtain a searched result.

2. The network information searching method according to claim 1, wherein the designated group is one of the web-site search engines.

3. The network information searching method according to claim 2, wherein the step of searching with the searching engine system to obtain the searched result comprises:
selecting one from the web-site search engines according to the designated group;
searching for the keyword with the selected web-site search engine, and generating a plurality of searched data; and
selecting a first N searched data as the searched result.

4. The network information searching method according to claim 2, wherein the step of searching with the searching engine system to obtain the searched result comprises:
selecting one from the web-site search engines according to the designated group;
searching for the keyword with the selected web-site search engine, and generating a plurality of searched data; and
comparing a similarity of the searched data, and selecting those having a predetermined weight as the searched result.

5. The network information searching method according to claim 1, wherein the designated group is a group set including the web-site search engines which are related one to another.

6. The network information searching method according to claim 5, wherein the step of searching with the searching engine system to obtain the searched result comprises:
selecting the searching engines included in the group set;
searching for the keyword with the selected web-site search engines, and generating a plurality of searched data corresponding to the web-site search engines; and
selecting a first N searched data as the searched result.

7. The network information searching method according to claim 5, wherein the step of searching with the searching engine system to obtain the searched result comprises:
selecting the searching engines contained in the group set;
searching for the keyword with the selected web-site search engines, and generating a plurality of searched data corresponding to the selected web-site search engines; and
comparing a similarity of the searched data corresponding to the selected web-site search engines, and selecting those having a predetermined weight as the searched result.

8. The network information searching method according to claim 5, wherein the group set is defined by the user.

9. A network information searching system, comprising:
a speech recognition module, for performing a speech recognition process on a voice signal to obtain a literal word series in a digital data form, wherein the voice signal conforms to a grammatical format and includes a designated group and a keyword;
an parsing module, for analyzing the literal word series according to the grammatical format, and retrieving the designated group and the keyword; and
a search engine system, coupled to the parsing module, for conducting a search according to the designated group and the keyword, and generating a searched result, wherein the search engine system is capable of searching with a plurality of web-site search engines.

10. The network information searching system according to claim 9, wherein the designated group is one of the web-site search engines.

11. The network information searching system according to claim 10, wherein the search engine system selects one from the web-site search engines for searching for the keyword with the selected web-site search engine, and generates a plurality of searched data.

12. The network information searching system according to claim 11 further comprising:
an analysis module, coupled to the search engine system for selecting a first N searching data as the searching result.

13. The network information searching system according to claim 11 further comprising:
an analysis module, coupled to the search engine system for comparing a similarity of the searched data, and selecting those having a predetermined weight as the searched result.

14. The network information searching system according to claim 9, wherein the designated group is a group set including the web-site search engines which are related to one to another.

15. The network information searching system according to claim 14, wherein the search engine system selects the web-site search engines included in the group set for searching for the keyword with the selected web-site search engines, and generates a plurality of searched data corresponding to the selected web-site search engines.

16. The network information searching system according to claim 15 further comprising:
an analysis module, coupled to the search engine system for selecting a first N searched data as the searched result.

17. The network information searching system according to claim 15 further comprising:
an analysis module, coupled to the search engine system for comparing a similarity of the searched data, and selecting those having a predetermined weight as the searched result.

18. The network information searching system according to claim 9 further comprising:
a searching definition module, for defining the web-site search engines, and providing for the search system to select.

19. The network information searching system according to claim 18, wherein the searching definition module further defines the web-site search engines which are related to one to another as a group set.

20. The network information searching system according to claim 18 further comprising:
a lexicon model, including a plurality of words and expanding words related to the web-site search engines via the searching definition module, wherein the speech recognition process searches for related words from the lexicon model according to the voice signal, and generates the literal word series according to a grammatical assembly probability; and
a language model, for providing the grammatical assembly probability to the speech recognition module according to an interrelation between the searched words and the grammatical format.
